(19) United States
(12) Patent Application Publication
(10) Pub. No.: US 2025/0298349 A1
(43) Pub. Date: Sep. 25, 2025

(54) FIXING DEVICE AND IMAGE FORMING APPARATUS

(71) Applicant: FUJIFILM Business Innovation Corp., Tokyo (JP)

(72) Inventors: Takashi OHASHI, Kanagawa (JP); Takashi MATSUBARA, Kanagawa (JP); Takuma ISHIHARA, Kanagawa (JP); Hina SAITO, Kanagawa (JP); Sodai HIGUCHI, Kanagawa (JP)

(73) Assignee: FUJIFILM Business Innovation Corp., Tokyo (JP)

(21) Appl. No.: 18/770,605

(22) Filed: Jul. 11, 2024

(30) Foreign Application Priority Data
Mar. 19, 2024 (JP) 2024-043615

(51) Int. Cl. G03G 15/20

(52) U.S. Cl. CPC G03G 15/2053; G03G 15/2064; G03G 2215/2016

(57) ABSTRACT

A fixing device includes a moving member that circularly moves, a pressure applying member that is disposed to be in contact with an outer peripheral surface of the moving member, that is used to press a recording medium on which an image is formed, that rotates as the pressure applying member receives a driving force from a drive source, and that presses the recording medium passing through a contact portion between the outer peripheral surface and the pressure applying member, a pressing member that is disposed inside the moving member, that is urged toward the pressure applying member, that is pressed against the pressure applying member with the moving member interposed therebetween, and that is provided to be movable in a direction away from the pressure applying member, and a restriction portion that restricts movement of the pressure applying member that is caused to move in a direction away from the outer peripheral surface of the moving member as the driving force is transmitted from the drive source to the pressure applying member.

### CROSS-REFERENCE TO RELATED APPLICATIONS

This application is based on and claims priority under 35 USC 119 from Japanese Patent Application No. 2024-043615 filed Mar. 19, 2024.

### BACKGROUND

### (i) Technical Field

The present invention relates to a fixing device and an image forming apparatus.

### (ii) Related Art

Disclosed in JP2014-44257A is a configuration in which a pad member that supports a fixation belt at a fixation nip such that an outlet-side peak pressure on recording paper is made equal to or smaller than an inlet-side peak pressure is provided.

Disclosed in JP2016-206644A is a drive transmission device that rotates integrally with a driving target device including a driving target rotary body which is a driving target and a direction in which the drive transmission device rotates is approximately orthogonal to a direction in which a driving reaction force acts as the driving target rotary body is driven.

Disclosed in JP2017-3606A is a configuration in which a heating roller is disposed at a position separated from a fixation pad serving as a fixation member and a fixation belt is looped over the heating roller and the fixation pad.

### SUMMARY

In some cases of fixation of an image on a recording medium, for example, the recording medium is transported to a position between a pressure applying member that rotates as the pressure applying member receives a driving force from a drive source and a pressing member that is pressed against the pressure applying member so that the image is fixed onto the recording medium.

Here, in the case of a configuration in which the pressure applying member is movable, the pressure applying member moves in a case where a thick recording medium passes through the position between the members and thus an image can be fixed onto the thick recording medium also. Meanwhile, in the case of a configuration in which the pressure applying member is movable, the position of the pressure applying member is likely to be changed due to a fluctuation in driving force transmitted from a drive source to the pressure applying member and in this case, a fluctuation in fixation performance is likely to occur.

Aspects of non-limiting embodiments of the present disclosure relate to a fixing device and an image forming apparatus that suppress a fluctuation in image fixation performance in comparison with a configuration, in which a restriction portion restricting movement of a pressure applying member is not provided, while enabling fixation of images onto a plurality of types of recording mediums different from each other in thickness.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a moving member that circularly moves, a pressure applying member that is disposed to be in contact with an outer peripheral surface of the moving member, that is used to press a recording medium on which an image is formed, that rotates as the pressure applying member receives a driving force from a drive source, and that presses the recording medium passing through a contact portion between the outer peripheral surface and the pressure applying member, a pressing member that is disposed inside the moving member, that is urged toward the pressure applying member, that is pressed against the pressure applying member with the moving member interposed therebetween, and that is provided to be movable in a direction away from the pressure applying member, and a restriction portion that restricts movement of the pressure applying member that is caused to move in a direction away from the outer peripheral surface of the moving member as the driving force is transmitted from the drive source to the pressure applying member.

### BRIEF DESCRIPTION OF THE DRAWINGS

Exemplary embodiment(s) of the present invention will be described in detail based on the following figures, wherein:

FIG. 1 is a view illustrating an image forming apparatus;

FIG. 2 is a view showing a configuration of a control unit;

FIG. 3 is a view showing a configuration of a fixing device;

FIG. 4 is a view of a moving member, a pressing member, an upstream-side paper sheet guide portion, and connection members as seen from a direction represented by an arrow IV in FIG. 3;

FIGS. 5A and 5B are views showing the way in which the pressing member and the upstream-side paper sheet guide portion move;

FIG. 6 is a view of a configuration of a portion of the fixing device as seen in a direction represented by an arrow VI in FIG. 3;

FIG. 7 is a view showing another configuration example of the fixing device;

FIG. 8 is a view for description of a movement mechanism that moves a pressure applying member; and

FIG. 9 is a view showing another configuration example of the movement mechanism.

### DETAILED DESCRIPTION OF THE INVENTION

An exemplary embodiment of the present invention will be described below with reference to the accompanying drawings.

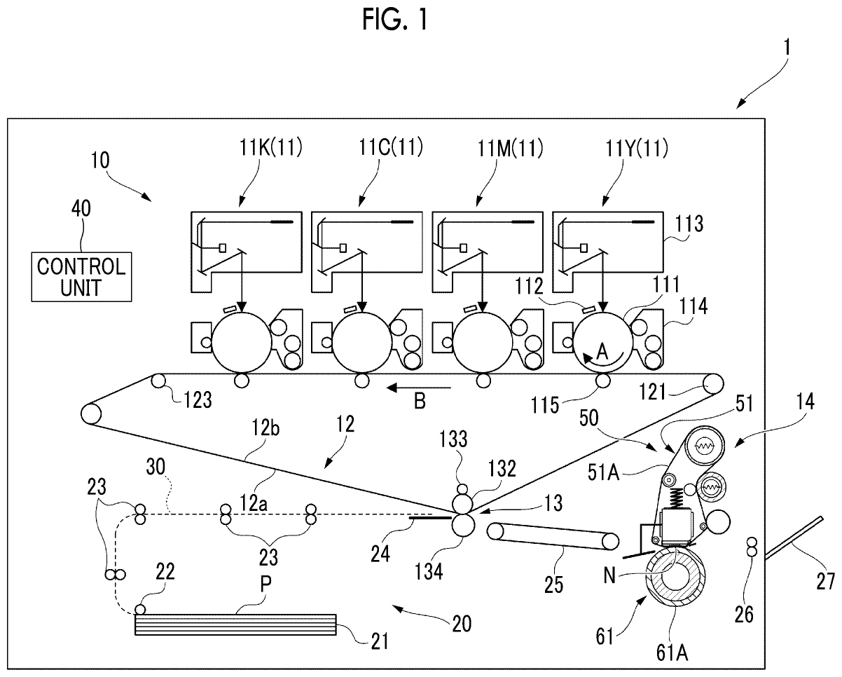

FIG. 1 is a view showing an image forming apparatus 1 according to the present exemplary embodiment.

The image forming apparatus 1 is a device that forms an image on a paper sheet P.

The image forming apparatus 1 is provided with an image forming section 10, a fixing device 14, a paper sheet transport section 20, and a control unit 40.

In the present exemplary embodiment, the image forming section 10 and the paper sheet transport section 20 function as an image formation unit that forms an image on the paper sheet P, which is an example of a recording medium.

The image forming section 10 is provided with image forming units 11, an intermediate transfer belt 12, and a secondary transfer unit 13.

In the present exemplary embodiment, four image forming units 11Y, 11M, 11C, and 11K respectively corresponding to toners of four colors which are yellow (Y), magenta (M), cyan (C), and black (K) are provided as the image forming units 11.

The image forming units 11Y, 11M, 11C, and 11K are arranged in a movement direction of the intermediate transfer belt 12. The image forming units 11Y, 11M, 11C, and 11K form toner images by an electrophotographic method.

Each of the image forming units 11Y, 11M, 11C, and 11K includes a photoconductor drum 111, a charging unit 112, an exposure unit 113, a developing unit 114, and a primary transfer unit 115.

Each of the image forming units 11Y, 11M, 11C, and 11K forms a toner image having any color from among Y, M, C, or K. The formed toner image is transferred to the intermediate transfer belt 12. Accordingly, a toner image obtained by superimposing toner images of respective colors which are Y, M, C, and K onto each other is formed on the intermediate transfer belt 12.

The photoconductor drum 111 rotates in a direction along an arrow A at a speed determined in advance. An electrostatic latent image is formed on a peripheral surface of the photoconductor drum 111.

The charging unit 112 charges the peripheral surface of the photoconductor drum 111 at a potential determined in advance.

The exposure unit 113 irradiates the charged peripheral surface of the photoconductor drum 111 with light and forms the electrostatic latent image on the peripheral surface of the photoconductor drum 111.

The developing unit 114 causes a toner to adhere to the electrostatic latent image formed on the peripheral surface of the photoconductor drum 111. Accordingly, a toner image is formed on the peripheral surface of the photoconductor drum 111.

The primary transfer unit 115 transfers the toner image formed on the peripheral surface of the photoconductor drum 111 onto the intermediate transfer belt 12.

A voltage of which the polarity is opposite to toner charging polarity is applied to the primary transfer unit 115. Accordingly, the toner image formed on the peripheral surface of the photoconductor drum 111 is electrostatically attracted to the intermediate transfer belt 12, so that the toner image is formed on the intermediate transfer belt 12.

The intermediate transfer belt 12 is supported by a plurality of roll-shaped members disposed inside the intermediate transfer belt 12.

The intermediate transfer belt 12 is formed in an endless shape and circularly moves in a direction along an arrow B. In addition, the intermediate transfer belt 12 includes an outer peripheral surface 12a and an inner peripheral surface 12b.

The intermediate transfer belt 12 is used for toner image transportation. In the present exemplary embodiment, a toner image is formed on the outer peripheral surface 12a of the intermediate transfer belt 12 and the toner image proceeds to the secondary transfer unit 13 as the intermediate transfer belt 12 moves.

In the present exemplary embodiment, a driving roll 121 that is driven by a motor (not shown) and drives the intermediate transfer belt 12 is provided as a roll-shaped member disposed inside the intermediate transfer belt 12. In addition, an idle roll 123 and a backup roll 132 that support the intermediate transfer belt 12 are provided as other roll-shaped members.

These roll-shaped members are rotatably provided and are disposed to be in contact with the inner peripheral surface 12b of the intermediate transfer belt 12.

The paper sheet transport section 20 is provided with a paper sheet accommodation unit 21 that accommodates a plurality of paper sheets P in a stacked state and a pickup roll 22 that takes out and transports the paper sheet P accommodated in the paper sheet accommodation unit 21.

In addition, the paper sheet transport section 20 is provided with a transport roll 23 that transports the paper sheet P taken out by the pickup roll 22 along a paper sheet transport path 30 and a paper sheet guiding portion 24 that guides, to the secondary transfer unit 13, the paper sheet P transported by the transport roll 23.

Furthermore, the paper sheet transport section 20 is provided with a transport belt 25 that transports, to the fixing device 14, the paper sheet P after secondary transfer and a paper sheet transport unit 26 that transports, to a paper discharge portion 27, the paper sheet P after fixation.

The secondary transfer unit 13 is provided with a secondary transfer roll 134 that is disposed to be in contact with the outer peripheral surface 12a of the intermediate transfer belt 12 and the backup roll 132 that is disposed close to the inner peripheral surface 12b side of the intermediate transfer belt 12 and forms an electrode facing the secondary transfer roll 134.

In addition, in the present exemplary embodiment, a power supply roll 133 made of a metal, which applies a secondary transfer bias to the backup roll 132, is provided.

At the secondary transfer unit 13, a toner image transported to the secondary transfer unit 13 by the intermediate transfer belt 12 is transferred onto the paper sheet P transported from the paper sheet accommodation unit 21.

The fixing device 14 is disposed downstream of the secondary transfer unit 13 in a transport direction of the paper sheet P.

The fixing device 14 is provided with a heating module 50 including a heat source and a pressure applying member 61 pressed against the heating module 50.

The heating module 50 is provided with a moving member 51 that is formed in an annular shape and that circularly moves.

The pressure applying member 61 is used to press the paper sheet P on which a toner image has been formed. The pressure applying member 61 is disposed to be in contact with an outer peripheral surface 51A of the moving member 51. The pressure applying member 61 presses the paper sheet P that passes through a contact portion N between the outer peripheral surface 51A of the moving member 51 and an outer peripheral surface 61A of the pressure applying member 61.

In the present exemplary embodiment, the paper sheet P that has passed through the secondary transfer unit 13 is transported to the contact portion N where the outer peripheral surface 51A of the moving member 51 and the outer peripheral surface 61A of the pressure applying member 61 are in contact with each other. In the present exemplary embodiment, the paper sheet P passes through a position between the moving member 51 and the pressure applying member 61 at the contact portion N.

In a case where the paper sheet P passes through the contact portion N, the paper sheet P is heated and pressed. Accordingly, an unfixed toner image on the paper sheet P is fixed to the paper sheet P. Accordingly, an image consisting of the toner image is formed on the paper sheet P.

### Configuration of Control Unit

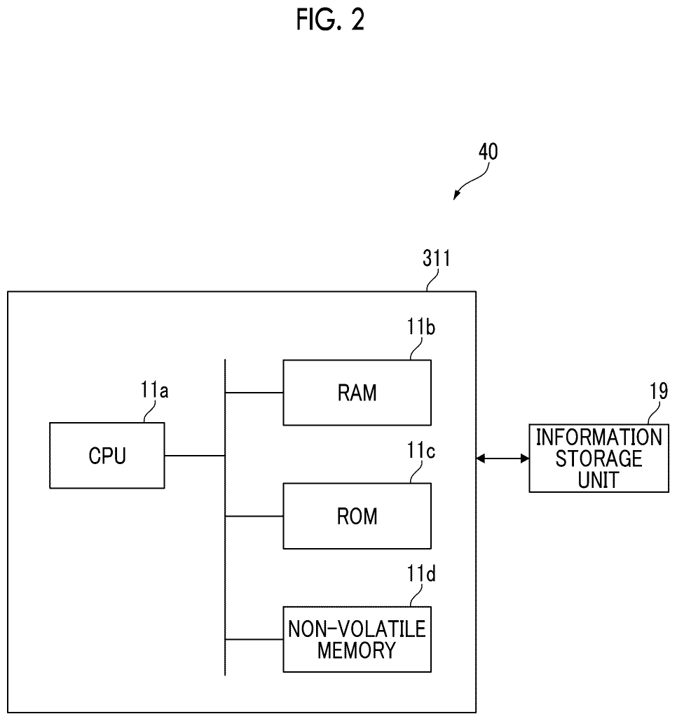

FIG. 2 is a diagram showing a configuration of the control unit 40. The control unit 40 is realized by a computer.

The control unit 40 includes an arithmetic processing unit 311 that executes a digital arithmetic process according to a program, and an information storage unit 19 that stores information.

The information storage unit 19 is realized, for example, by a known information storage device such as a hard disk drive (HDD), a semiconductor memory, or a magnetic tape.

The arithmetic processing unit 311 is provided with a CPU 11a which is an example of a processor.

In addition, the arithmetic processing unit 311 is provided with a RAM 11b used as a working memory or the like of the CPU 11a and a ROM 11c in which programs or the like executed by the CPU 11a are stored.

In addition, the arithmetic processing unit 311 is provided with a non-volatile memory 11d that is configured to be rewritable and that can hold data even in a case where power supply is interrupted.

The non-volatile memory 11d is composed of, for example, an SRAM or a flash memory that is backed up by a battery. The information storage unit 19 stores various types of information such as a program executed by the arithmetic processing unit 311.

In the present exemplary embodiment, processes in the control unit 40 are executed as the CPU 11a reads the program stored in the ROM 11c or the information storage unit 19.

The program to be executed by the CPU 11a may be provided for the control unit 40 in a state of being stored in a computer-readable recording medium such as a magnetic recording medium (a magnetic tape, a magnetic disk, or the like), an optical recording medium (an optical disk or the like), a magnetooptical recording medium, or a semiconductor memory. In addition, the program to be executed by the CPU 11a may be provided for the control unit 40 by means of communication means like the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

### Configuration of Fixing Device

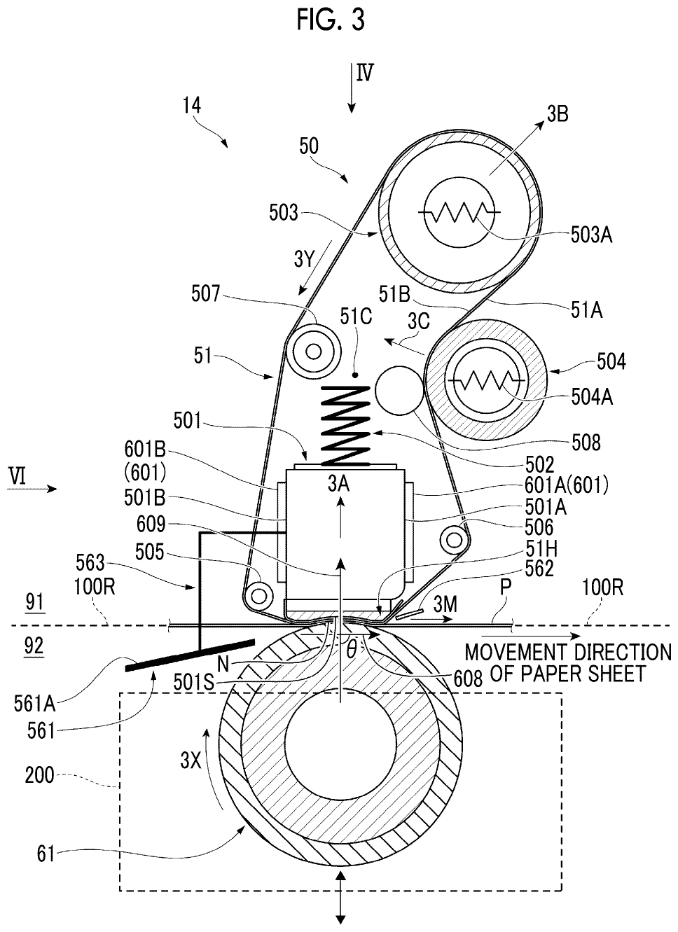

FIG. 3 is a view showing a configuration of the fixing device 14.

As described above, the fixing device 14 is provided with the heating module 50 including a heat source and the pressure applying member 61 pressed against the heating module 50.

Furthermore, the fixing device 14 is provided with a movement mechanism 200 that moves the pressure applying member 61. In the present exemplary embodiment, the pressure applying member 61 is moved forward and backward with respect to the heating module 50 by the movement mechanism 200. Details of the movement mechanism 200 will be described below.

As described above, the heating module 50 is provided with the moving member 51 that is formed in the annular shape and that circularly moves. In other words, the heating module 50 is provided with the moving member 51 that is formed in an endless shape and that moves in a revolving manner.

The moving member 51 is composed of a belt-shaped member. In the present exemplary embodiment, the moving member 51 moves in a revolving manner as the moving member 51 receives a force from the pressure applying member 61 that rotates.

The pressure applying member 61 is composed of a columnar body or a cylindrical body. The pressure applying member 61 is a rotating body that rotates. The pressure applying member 61 is disposed to be in contact with an outer peripheral surface 51A of the moving member 51.

The pressure applying member 61 is used to press the paper sheet P on which a toner image, which is an example of an image, has been formed. The pressure applying member 61 presses the paper sheet P passing through the contact portion N.

Next, the heating module 50 will be described.

The heating module 50 is provided with a pressing member 501.

The pressing member 501 is composed of a pad-shaped member. In addition, the pressing member 501 is disposed inside the moving member 51. In addition, the pressing member 501 is disposed to be in contact with an inner peripheral surface 51B of the moving member 51.

The pressing member 501 includes a downstream-side end portion 501A which is an end portion positioned on a downstream side in a movement direction of the paper sheet P and an upstream-side end portion 501B which is an end portion positioned on an upstream side in the movement direction of the paper sheet P.

The pressing member 501 is urged toward the pressure applying member 61 and is pressed against the pressure applying member 61 with the moving member 51 interposed therebetween.

In the present exemplary embodiment, an urging member 502 that urges the pressing member 501 toward the pressure applying member 61 is provided, and the pressing member 501 is urged toward the pressure applying member 61 by the urging member 502.

The pressing member 501 is provided in a state where the pressing member 501 can withdraw from the pressure applying member 61 and is movable in a direction away from the pressure applying member 61.

Examples of the urging member 502 include a spring member. In the present exemplary embodiment, one end portion of the urging member 502 is disposed to be in contact with the pressing member 501 and the other end portion of the urging member 502 is supported by a device body (not shown) side of the fixing device 14.

In the present exemplary embodiment, the pressing member 501 is moved in a direction represented by an arrow 3A, which is a direction away from the pressure applying member 61, against an urging force acting on the pressing member 501 from the urging member 502.

In the present exemplary embodiment, in a case where the paper sheet P passes through the contact portion N, the pressing member 501 moves in a direction away from the pressure applying member 61 by a distance corresponding to the thickness of the paper sheet P.

In a case where the paper sheet P is a thick paper sheet or the like, the larger the thickness of the paper sheet P is, the larger the amount of movement of the pressing member 501 is.

In the present exemplary embodiment, in a case where the paper sheet P passes through the contact portion N, the paper sheet P passes through a position between the pressing member 501 and the pressure applying member 61.

In the present exemplary embodiment, at the contact portion N, the paper sheet P is sandwiched by the pressing member 501 and the pressure applying member 61 and the paper sheet P is pressed by the pressing member 501 and the pressure applying member 61.

In addition, while the paper sheet P is being pressed, heat is transmitted from the moving member 51 or the pressure applying member 61 to the paper sheet P so that the paper sheet P is heated.

In addition, an inner pushing member 503 that pushes the moving member 51 is provided inside the moving member 51 of the heating module 50. The inner pushing member 503 pushes the inner peripheral surface 51B of the moving member 51 in a direction toward the outside of the moving member 51 formed in the annular shape.

The inner pushing member 503 is composed of a cylindrical member. In addition, the inner pushing member 503 is provided to be rotatable. Furthermore, the inner pushing member 503 is disposed on a side opposite to a side, on which the pressing member 501 is installed, with a rotation center 51C of the moving member 51 interposed therebetween.

In the present exemplary embodiment, a spring member (not shown) which is an example of an urging member is provided to correspond to each of one end portion and the other end portion of the inner pushing member 503 in an axial direction.

In the present exemplary embodiment, the spring members urge the one end portion and the other end portion of the inner pushing member 503 in a direction toward the outside of the moving member 51 formed in the annular shape. Specifically, the one end portion and the other end portion of the inner pushing member 503 are urged in a direction represented by an arrow 3B.

Accordingly, the inner pushing member 503 is pressed against the inner peripheral surface 51B of the moving member 51 and the inner pushing member 503 pushes the inner peripheral surface 51B of the moving member 51.

In a case where the inner peripheral surface 51B of the moving member 51 is pushed by the inner pushing member 503, a tensile force is applied to the moving member 51.

A heat source 503A used to heat the inner pushing member 503 is provided inside the inner pushing member 503. The heat source 503A is composed of a halogen heater or the like. In the present exemplary embodiment, the inner pushing member 503 is heated by the heat source 503A.

In addition, in the present exemplary embodiment, heat is transmitted to the moving member 51 from the inner pushing member 503 that is heated by the heat source 503A, so that and the moving member 51 is heated.

Furthermore, in the heating module 50 of the present exemplary embodiment, an outer pushing member 504 that pushes the moving member 51 is provided outside the moving member 51.

The outer pushing member 504 pushes the outer peripheral surface 51A of the moving member 51 toward the inside of the moving member 51 formed in the annular shape. The outer pushing member 504 is composed of a cylindrical member. In addition, the outer pushing member 504 is provided to be rotatable.

In the present exemplary embodiment, a spring member (not shown) which is an example of an urging member is provided to correspond to each of one end portion and the other end portion of the outer pushing member 504 in an axial direction.

In the present exemplary embodiment, the spring members urge the one end portion and the other end portion of the outer pushing member 504 in a direction toward the inside of the moving member 51 formed in the annular shape. Specifically, the one end portion and the other end portion of the outer pushing member 504 are urged in a direction represented by an arrow 3C.

Accordingly, the outer pushing member 504 is pressed against the outer peripheral surface 51A of the moving member 51 and the outer pushing member 504 pushes the outer peripheral surface 51A of the moving member 51.

In a case where the outer peripheral surface 51A of the moving member 51 is pushed by the outer pushing member 504, a tensile force is applied to the moving member 51.

A heat source 504A used to heat the outer pushing member 504 is provided inside the outer pushing member 504. The heat source 504A is composed of a halogen heater or the like. In the present exemplary embodiment, the outer pushing member 504 is heated by the heat source 504A.

In addition, in the present exemplary embodiment, heat is transmitted to the moving member 51 from the outer pushing member 504 that is heated by the heat source 504A, so that and the moving member 51 is heated.

In the present exemplary embodiment, as described above, a tensile force is applied to the moving member 51 by the inner pushing member 503 and the outer pushing member 504, but the way in which a tensile force is applied to the moving member 51 is not limited thereto.

It is not necessary to provide both of the inner pushing member 503 and the outer pushing member 504 for application of a tensile force to the moving member 51 and a configuration in which only one of the inner pushing member 503 and the outer pushing member 504 may also be adopted.

In addition, the heating module 50 of the present exemplary embodiment is provided with an upstream-side support member 505 that supports the moving member 51. The upstream-side support member 505 is disposed inside the moving member 51. In addition, the upstream-side support member 505 is disposed upstream of the contact portion N in the movement direction of the paper sheet P.

In addition, the upstream-side support member 505 is composed of a cylindrical member. Furthermore, the upstream-side support member 505 is provided to be rotatable.

The upstream-side support member 505 is disposed to be in contact with the inner peripheral surface 51B of the moving member 51 and supports the moving member 51 from the inside of the moving member 51.

In addition, the heating module 50 is provided with a downstream-side support member 506 that supports the moving member 51. The downstream-side support member 506 is also disposed inside the moving member 51. In addition, the downstream-side support member 506 is disposed downstream of the contact portion N in the movement direction of the paper sheet P.

The downstream-side support member 506 is composed of a cylindrical member. In addition, the downstream-side support member 506 is provided to be rotatable.

The downstream-side support member 506 is disposed to be in contact with the inner peripheral surface 51B of the moving member 51 and supports the moving member 51 from the inside of the moving member 51.

In the present exemplary embodiment, as described above, the outer pushing member 504 that pushes the outer peripheral surface 51A of the moving member 51 is provided. The outer pushing member 504 pushes a portion of the moving member 51 that is positioned between the downstream-side support member 506 and the inner pushing member 503 in a direction toward the inside of the moving member 51.

In addition, the heating module 50 is provided with an intermediate support member 507 that supports the moving member 51.

The intermediate support member 507 is disposed inside the moving member 51. In addition, the intermediate support member 507 is disposed downstream of the inner pushing member 503 in the movement direction of the moving member 51 and is disposed upstream of the upstream-side support member 505 in the movement direction of the moving member 51.

In addition, the intermediate support member 507 is composed of a cylindrical member. Furthermore, the intermediate support member 507 is provided to be rotatable.

The intermediate support member 507 is disposed to be in contact with the inner peripheral surface 51B of the moving member 51 and supports the moving member 51.

Furthermore, the heating module 50 is provided with a facing member 508.

The facing member 508 is disposed inside the moving member 51. In addition, the facing member 508 is disposed at a position facing the outer pushing member 504.

In the present exemplary embodiment, the outer pushing member 504 is pressed against the facing member 508 with the moving member 51 interposed therebetween. In the present exemplary embodiment, the outer pushing member 504 is supported by the facing member 508 from the inside by the moving member 51.

The pressure applying member 61 rotates in a direction represented by an arrow 3X in the drawing as the pressure applying member 61 receives a driving force from a driving motor (which will be described later) which is an example of a drive source.

In a case where the pressure applying member 61 rotates, a driving force is transmitted from the pressure applying member 61 to the moving member 51, and the moving member 51 is moved in a direction represented by an arrow 3Y in the drawing.

In a case where the moving member 51 moves, the inner pushing member 503, the outer pushing member 504, the upstream-side support member 505, the downstream-side support member 506, the intermediate support member 507, and the facing member 508 rotate by being driven by the moving member 51.

Furthermore, in the present exemplary embodiment, an upstream-side paper sheet guide portion 561 that guides the paper sheet P proceeding toward the contact portion N is provided.

The upstream-side paper sheet guide portion 561 is disposed upstream of the contact portion N in the movement direction of the paper sheet P. In addition, the upstream-side paper sheet guide portion 561 is disposed below a movement route 100R of the paper sheet P.

The upstream-side paper sheet guide portion 561 is composed of a plate-shaped member and guides the paper sheet P passing through the movement route 100R by using one surface 561A positioned close to the movement route 100R side of the paper sheet P.

The upstream-side paper sheet guide portion 561 is provided such that the upstream-side paper sheet guide portion 561 becomes closer to the movement route 100R toward a downstream side in the movement direction of the paper sheet P.

In the present exemplary embodiment, the upstream-side paper sheet guide portion 561 is provided to move in conjunction with the pressing member 501.

In the present exemplary embodiment, connection members 563 that connect the pressing member 501 and the upstream-side paper sheet guide portion 561 to each other are provided. Due to the connection members 563, the upstream-side paper sheet guide portion 561 moves in conjunction with the pressing member 501.

In the present exemplary embodiment, the connection members 563 move as the pressing member 501 moves and the upstream-side paper sheet guide portion 561 moves as the connection members 563 move.

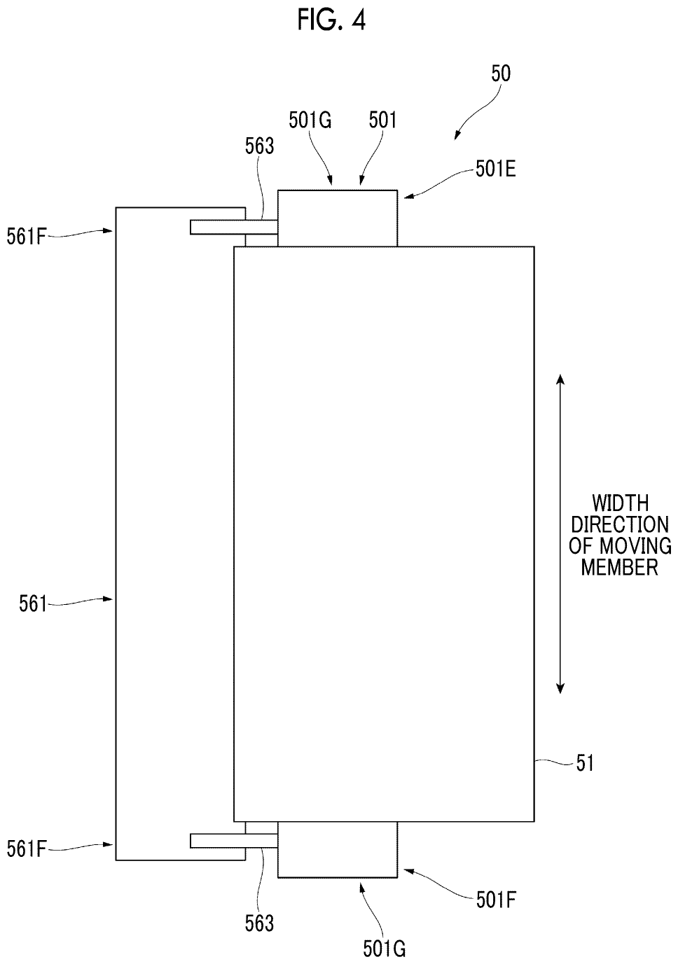

FIG. 4 is a view of the moving member 51, the pressing member 501, the upstream-side paper sheet guide portion 561, and the connection members 563 as seen from a direction represented by an arrow IV in FIG. 3.

As shown in FIG. 4, the connection member 563 is provided to correspond to each of one end portion 501E and the other end portion 501F of the pressing member 501 in a longitudinal direction and two connection members 563 are provided.

Each of the connection members 563 is provided outside the moving member 51 formed in the annular shape in a width direction of the moving member 51. Each of the connection members 563 connects an outer portion 501G, which is a portion of the pressing member 501 that is positioned outside the moving member 51, to an end portion 561F of the upstream-side paper sheet guide portion 561 in a longitudinal direction.

Description about Movement of Pressing Member and Upstream-Side Paper Sheet Guide Portion

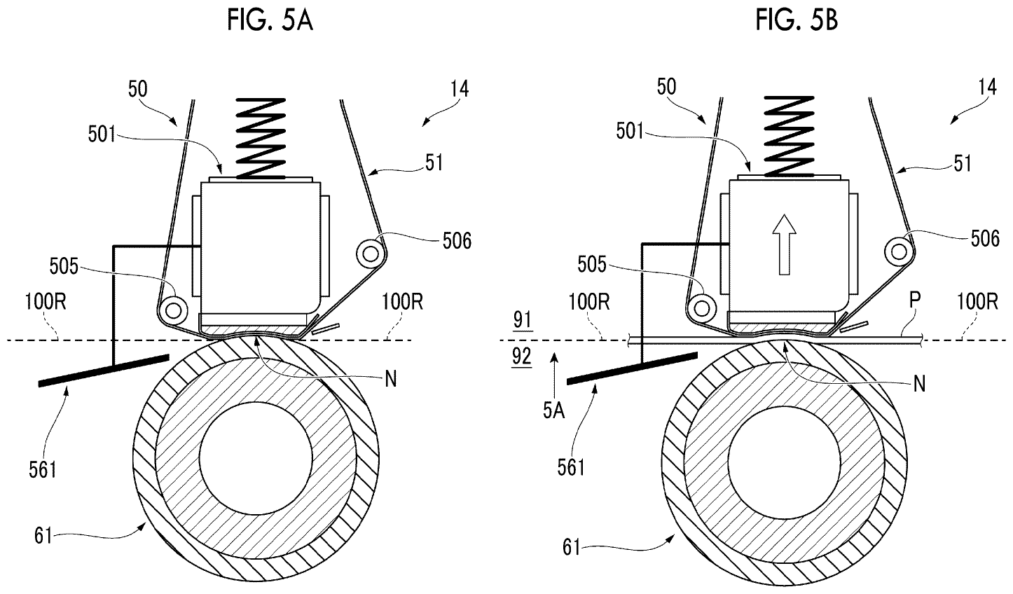

FIGS. 5A and 5B are views showing the way in which the pressing member 501 and the upstream-side paper sheet guide portion 561 move.

FIG. 5A shows a state before movement of the pressing member 501 and FIG. 5B shows a state after movement of the pressing member 501.

In the present exemplary embodiment, as described above, the pressing member 501 is provided to be movable in a direction away from the pressure applying member 61.

FIG. 5B shows a state after movement of the pressing member 501 in the direction away from the pressure applying member 61. In the present exemplary embodiment, in a case where the paper sheet P passes through the contact portion N, the pressing member 501 moves in the direction away from the pressure applying member 61 as shown in FIG. 5B.

In a case where the pressing member 501 is moved in the direction away from the pressure applying member 61, the upstream-side paper sheet guide portion 561 moves in a direction represented by an arrow 5A in FIG. 5B in response to the movement of the pressing member 501.

In the present exemplary embodiment, the position of the upstream-side paper sheet guide portion 561 with respect to the movement route 100R of the paper sheet P changes in response to the movement of the pressing member 501 in the direction away from the pressure applying member 61.

Specifically, in the present exemplary embodiment, in response to the movement of the pressing member 501 in the direction away from the pressure applying member 61, the upstream-side paper sheet guide portion 561 is moved to a side on which the movement route 100R is provided as represented by the arrow 5A in FIG. 5B.

In the present exemplary embodiment, in a case where the paper sheet P passes through the contact portion N, the pressing member 501 moves in the direction away from the pressure applying member 61 as shown in FIG. 5B.

In this case, the upstream-side paper sheet guide portion 561 moves in conjunction with the pressing member 501, and the upstream-side paper sheet guide portion 561 moves to a side on which the movement route 100R is provided.

In the present exemplary embodiment, the moving member 51 and the pressing member 501 are provided on one side 91 (refer to FIG. 5B) with respect to the movement route 100R of the paper sheet P. In other words, in the present exemplary embodiment, the heating module 50 is provided on the one side 91 with respect to the movement route 100R of the paper sheet P.

In addition, in the present exemplary embodiment, the upstream-side paper sheet guide portion 561 is provided on the other side 92 with respect to the movement route 100R of the paper sheet P.

In the present exemplary embodiment, the upstream-side paper sheet guide portion 561 positioned on the other side 92 is moved to a side on which the movement route 100R is provided in response to movement of the pressing member 501 in the direction away from the pressure applying member 61.

In other words, in the present exemplary embodiment, the upstream-side paper sheet guide portion 561 positioned on the other side 92 is moved to the one side 91 in response to the movement of the pressing member 501 in the direction away from the pressure applying member 61.

### Description About Downstream-Side Paper Sheet Guide Portion and Like

Furthermore, in the present exemplary embodiment, a downstream-side paper sheet guide portion 562, which is a guide portion that guides the paper sheet P passing through the contact portion N, is provided as shown in FIG. 3.

The downstream-side paper sheet guide portion 562 is disposed on downstream of the contact portion N in the movement direction of the paper sheet P. In addition, the downstream-side paper sheet guide portion 562 is provided on the one side 91 with respect to the movement route 100R of the paper sheet P.

The downstream-side paper sheet guide portion 562 also moves in conjunction with the pressing member 501.

Although not shown, in the present exemplary embodiment, a downstream-side connection member that connects the pressing member 501 and the downstream-side paper sheet guide portion 562 to each other is provided. In the present exemplary embodiment, the downstream-side paper sheet guide portion 562 is moved in conjunction with the pressing member 501 by the downstream-side connection member.

The downstream-side connection member is configured in the same manner as the connection members 563.

The downstream-side connection member connects a portion of the pressing member 501 that is positioned outside the moving member 51 to one end portion of the downstream-side paper sheet guide portion 562 in a longitudinal direction. In addition, the downstream-side connection member connects a portion of the pressing member 501 that is positioned outside the moving member 51 to the other end portion of the downstream-side paper sheet guide portion 562 in the longitudinal direction.

In the present exemplary embodiment, in a case where the pressing member 501 is moved in the direction away from the pressure applying member 61, the downstream-side paper sheet guide portion 562 disposed on the one side 91 is moved to approach the outer peripheral surface 51A of the moving member 51.

Furthermore, in the fixing device 14 of the present exemplary embodiment, as shown in FIG. 3, guide portions 601 that guide the pressing member 501 are provided.

In the present exemplary embodiment, the pressing member 501 moves in the direction away from the pressure applying member 61 as described above. In the case of such movement of the pressing member 501, the guide portions 601 guide the pressing member 501.

In the present exemplary embodiment, as the guide portions 601, a downstream-side guide portion 601A that guides the downstream-side end portion 501A of the pressing member 501 and an upstream-side guide portion 601B that guides the upstream-side end portion 501B of the pressing member 501 are provided.

Each of the upstream-side guide portion 601B and the downstream-side guide portion 601A is formed in a linear shape. Furthermore, the upstream-side guide portion 601B and the downstream-side guide portion 601A are disposed to be parallel to each other.

In the present exemplary embodiment, the pressing member 501 is guided such that the pressing member 501 is moved in the direction away from the pressure applying member 61 in a state where the posture of the pressing member 501 is maintained.

The guide portions 601 of the present exemplary embodiment guide the pressing member 501 such that the pressing member 501 moves in the direction away from the pressure applying member 61 in a state where the posture of the pressing member 501 before movement of the pressing member 501 in the direction away from the pressure applying member 61 is maintained.

The pressing member 501 includes a contact surface 501S that comes into contact with the inner peripheral surface 51B of the moving member 51.

Here, as shown in FIG. 3, an extending direction 608, which is a direction in which the contact surface 501S of the pressing member 501 extends and a direction toward the downstream side in the movement direction of the paper sheet P will be assumed. Furthermore, a movement direction 609 in the case of movement of the pressing member 501 in the direction away from the pressure applying member 61 will be assumed.

In the present exemplary embodiment, the pressing member 501 is guided by the guide portions 601 such that the pressing member 501 moves in a state where an angle θ formed by the extending direction 608 and the movement direction 609 is maintained.

In the present exemplary embodiment, as described above, the pressing member 501 is moved in the direction away from the pressure applying member 61 in a state where the posture of the pressing member 501 is maintained and in the present exemplary embodiment, the posture of the pressing member 501 is maintained since the angle θ formed between the directions is maintained.

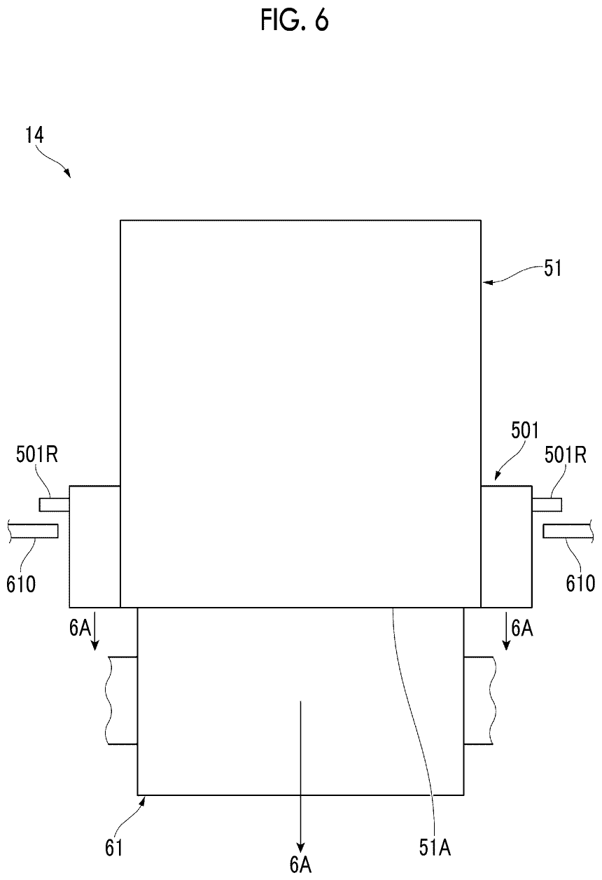

FIG. 6 is a view of a configuration of a portion of the fixing device 14 as seen in a direction represented by an arrow VI in FIG. 3. In other words, FIG. 6 is a view showing a state where the moving member 51, the pressing member 501, the pressure applying member 61, and the like are seen from the upstream side in the movement direction of the paper sheet P. In FIG. 6, the upstream-side paper sheet guide portion 561 and the like are not shown.

The fixing device 14 according to the present exemplary embodiment is further provided with a restriction portion 610 that restricts movement of the pressing member 501.

In the present exemplary embodiment, as the pressure applying member 61 moves in a direction away from the outer peripheral surface 51A of the moving member 51, the pressing member 501 moves toward the pressure applying member 61 side, which is a side on which the pressure applying member 61 is positioned, as represented by an arrow 6A.

In the present exemplary embodiment, the pressing member 501 is urged toward the pressure applying member 61 by the urging member 502 (refer to FIG. 3).

In a case where the pressure applying member 61 moves in a direction represented by the arrow 6A in FIG. 6, which is the direction away from the outer peripheral surface 51A of the moving member 51, the pressing member 501 moves toward the pressure applying member 61 side by being urged by the urging member 502.

In this case, in the present exemplary embodiment, an interlocked portion 501R that moves in conjunction with the pressing member 501 abuts against the restriction portion 610, so that movement of the pressing member 501 is restricted.

Accordingly, in the present exemplary embodiment, an increase in tensile force acting on the moving member 51 is suppressed.

In the present exemplary embodiment, a force from the urging member 502 that urges the pressing member 501 acts on the moving member 51 via the pressing member 501.

In the case of a configuration in which the restriction portion 610 is not provided, the amount of movement of the pressing member 501 toward the pressure applying member 61 side is large, and a tensile force on the moving member 51 is likely to be large. In a case where a tensile force on the moving member 51 is large, a problem such as a decrease in lifespan of the moving member 51 may occur.

On the other hand, in a case where the movement of the pressing member 501 is restricted and the increase in tensile force on the moving member 51 is suppressed as in the present exemplary embodiment, a problem such as a decrease in lifespan of the moving member 51 is less likely to occur.

In the present exemplary embodiment, in a state where the pressure applying member 61 is pressed against the outer peripheral surface 51A of the moving member 51, the pressing member 501 is pushed in a direction toward the inside of the moving member 51 by the pressure applying member 61. In this case, a force from the urging member 502 is less likely to act on the moving member 51 and thus an increase in tensile force on the moving member 51 is suppressed.

In a case where the pressure applying member 61 is moved in the direction away from the outer peripheral surface 51A of the moving member 51, the pressing member 501 is moved in a direction toward the outside of the moving member 51. In this case, a tensile force on the moving member 51 is made large.

In this case, in a case where the restriction portion 610 is provided as in the present exemplary embodiment, movement of the pressing member 501 is restricted and thus an increase in tensile force acting on the moving member 51 is suppressed.

In the present exemplary embodiment, in order to secure a tensile force on the moving member 51 related to a state where the pressing member 501 is pushed by the pressure applying member 61, the inner pushing member 503 (refer to FIG. 3) and the outer pushing member 504 are provided.

In the present exemplary embodiment, in a state where the pressing member 501 is pushed in a direction toward the inside of the moving member 51 by the pressure applying member 61, a tensile force on the moving member 51 is small.

In a case where a tensile force on the moving member 51 is excessively small, a problem such as deformation of the moving member 51 is likely to occur in a case where the moving member 51 circularly moves.

On the other hand, in the present exemplary embodiment, the inner pushing member 503 and the outer pushing member 504 are provided and thus a tensile force is applied to the moving member 51 in a state where the pressing member 501 is pushed by the pressure applying member 61.

In the present exemplary embodiment, the inner peripheral surface 51B and the outer peripheral surface 51A of the moving member 51 are pushed by the inner pushing member 503 and the outer pushing member 504. Accordingly, in a state where the pressing member 501 is pushed by the pressure applying member 61, the inner pushing member 503 and the outer pushing member 504 apply a tensile force to the moving member 51.

### Another Configuration Example of Fixing Device

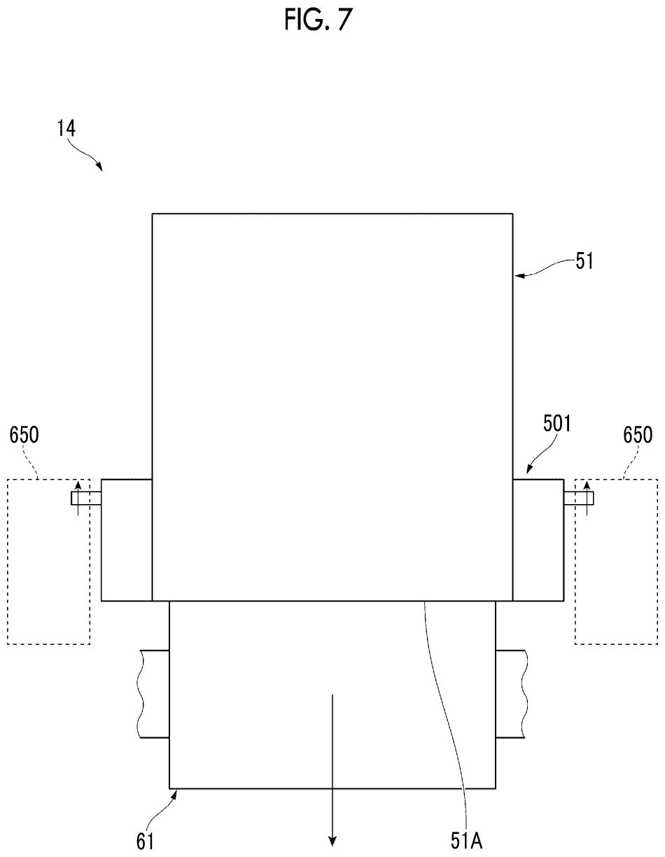

FIG. 7 is a view showing another configuration example of the fixing device 14. FIG. 7 also shows a state where the fixing device 14 is seen from the upstream side in the movement direction of the paper sheet P.

In this configuration example shown in FIG. 7, a movement mechanism 650 that moves the pressing member 501 in the direction away from the pressure applying member 61 is provided.

In this configuration example shown in FIG. 7, in a case where the pressure applying member 61 is moved in the direction away from the outer peripheral surface 51A of the moving member 51, the movement mechanism 650 moves the pressing member 501 in the direction away from the pressure applying member 61.

More specifically, in this configuration example, the CPU 11a which is an example of the processor and is provided in the control unit 40 (refer to FIG. 2) outputs a control signal causing the movement mechanism 650 to operate in a case where the pressure applying member 61 is moved in the direction away from the outer peripheral surface 51A.

Specifically, the CPU 11a outputs a control signal such that the pressing member 501 is moved in the direction away from the pressure applying member 61.

Accordingly, the movement mechanism 650 operates and the pressing member 501 is moved in the direction away from the pressure applying member 61. Accordingly, even in this case, an increase in tensile force on the moving member 51 caused by movement of the pressing member 501 to the pressure applying member 61 side may be suppressed.

Note that the movement mechanism 650 is not particularly limited and an existing mechanism may also be used. For example, a well-known mechanism in which a cam, a solenoid, a motor, or the like is used may also be used.

### Movement Mechanism for Pressure Applying Member

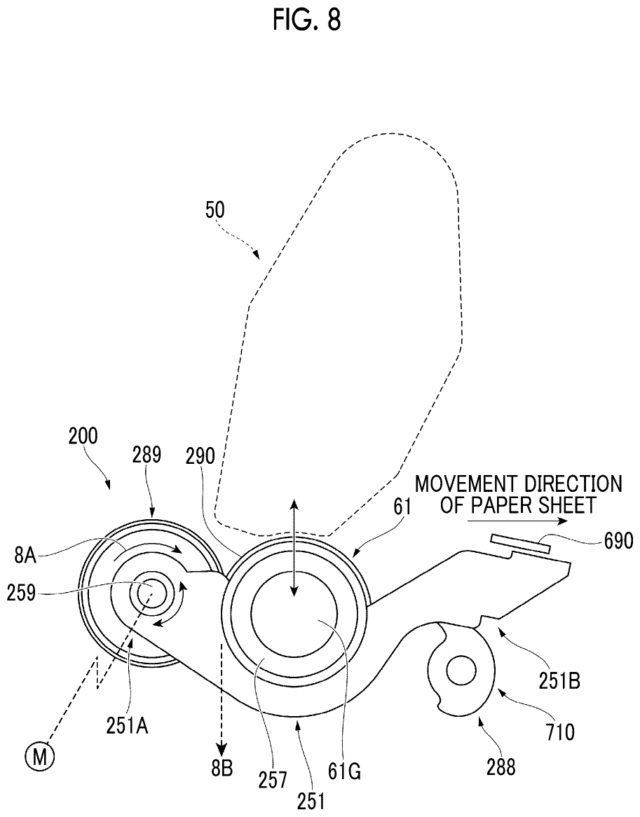

FIG. 8 is a view for description of the movement mechanism 200 that moves the pressure applying member 61. In addition, in FIG. 8, the details of the heating module 50 are not shown.

In the present exemplary embodiment, as shown in FIG. 3, the movement mechanism 200 that moves the pressure applying member 61 is provided.

In the present exemplary embodiment, the movement mechanism 200 moves the pressure applying member 61 in the direction away from the moving member 51 (refer to FIG. 3) and moves the pressure applying member 61 toward the moving member 51.

In the present exemplary embodiment, as described above, the pressure applying member 61 is provided to be movable in the direction away from the outer peripheral surface 51A of the moving member 51 and the movement mechanism 200 causes the pressure applying member 61 to move in such a manner.

In the present exemplary embodiment, as shown in FIG. 8, support members 251 that support the pressure applying member 61 are provided as members constituting a portion of the movement mechanism 200.

Each support member 251 includes one end portion 251A and the other end portion 251B. The one end portion 251A and the other end portion 251B are disposed such that the positions thereof in the movement direction of the paper sheet P are different from each other.

In the present exemplary embodiment, the one end portion 251A of the support member 251 is supported by the device body (not shown) of the fixing device 14. Furthermore, the support member 251 is rotatable around a rotary shaft 259 provided at the one end portion 251A.

In the present exemplary embodiment, the pressure applying member 61 is supported by a portion of the support member 251 that is positioned between the one end portion 251A and the other end portion 251B.

The support members 251 each including the one end portion 251A and the other end portion 251B are provided to support both one end portion 61G and the other end portion (not shown) of the pressure applying member 61 in the axial direction.

FIG. 8 shows a state where the one end portion 61G of the pressure applying member 61 in the axial direction is supported by the support member 251. However, the other end portion of the pressure applying member 61 in the axial direction is also provided with the support member 251 that supports the other end portion.

The support member 251 that supports the one end portion 61G of the pressure applying member 61 in the axial direction and the support member 251 that supports the other end portion of the pressure applying member 61 in the axial direction are connected to each other and move in synchronization with each other.

In the present exemplary embodiment, both the one end portion 61G and the other end portion of the pressure applying member 61 are supported by the support members 251. Note that bearings 257 are provided between the support members 251 and the pressure applying member 61.

Furthermore, in the present exemplary embodiment, cams 288 that support the other end portions 251B of the support members 251 from below are provided. In the present exemplary embodiment, the other end portions 251B of the support members 251 move up and down as the cams 288 are rotated by a driving motor (not shown).

In a case where the other end portions 251B of the support member 251 move up and down, the pressure applying member 61 moves forward and backward with respect to the outer peripheral surface 51A of the moving member 51 (refer to FIG. 3).

Furthermore, the movement mechanism 200 is provided with a transmission gear 289 for transmission of a rotary driving force to the pressure applying member 61. The transmission gear 289 is rotated by a driving motor M which is an example of a drive source, and as the transmission gear 289 is rotated, a rotary driving force is transmitted from the transmission gear 289 to the pressure applying member 61.

Specifically, a receiving gear 290 that receives a driving force from the transmission gear 289 is attached to the one end portion 61G of the pressure applying member 61 in the axial direction, and a rotary driving force from the driving motor M is transmitted to the pressure applying member 61 via the transmission gear 289 and the receiving gear 290.

Accordingly, the pressure applying member 61 rotates and the moving member 51 (refer to FIG. 3) moves in a revolving manner.

The transmission gear 289 is disposed to be coaxial with the rotary shaft 259 provided at one end portion 251A of the support member 251. In this case, connection between the transmission gear 289 and the receiving gear 290 is maintained even in a case where the support members 251 rotate around the rotary shaft 259.

In the present exemplary embodiment, the support members 251 move upward as the cams 288 rotate in one direction, and in this case, the pressure applying member 61 supported by the support members 251 is urged toward the outer peripheral surface 51A of the moving member 51 (refer to FIG. 3).

In addition, in the present exemplary embodiment, the support members 251 move downward as the cams 288 rotate in the opposite direction, and in this case, the pressure applying member 61 supported by the support members 251 moves in the direction away from the outer peripheral surface 51A of the moving member 51. Then, the pressure applying member 61 is separated from the outer peripheral surface 51A of the moving member 51.

Furthermore, the movement mechanism 200 of the present exemplary embodiment is provided with a restriction portion 690 that restricts the pressure applying member 61 from further moving in a direction toward the pressing member 501 side, which is a side on which the pressing member 501 (refer to FIG. 3) is positioned, in a state where the pressure applying member 61 is in contact with the outer peripheral surface 51A of the moving member 51. The restriction portion 690 is supported by the device body (not shown) of the fixing device 14.

In the present exemplary embodiment, a portion of each support member 251, which is an example of a movement portion that moves in conjunction with the pressure applying member 61, abuts the restriction portion 690 so that the pressure applying member 61 is restricted from moving toward the pressing member 501 side.

In a case where the cams 288 rotate in the one direction, the pressure applying member 61 comes into contact with the outer peripheral surface 51A of the moving member 51. In a case where the cams 288 further rotate in the one direction, the pressure applying member 61 is caused to further move toward the pressing member 501 side.

In this case, in the present exemplary embodiment, a portion of each support member 251 abuts against the restriction portion 690 or the pressure applying member 61 is restricted from moving toward the pressing member 501 side.

Furthermore, in the present exemplary embodiment, restriction portions 710 that restrict movement of the pressure applying member 61 in the direction away from the outer peripheral surface 51A of the moving member 51 are provided. In the present exemplary embodiment, the restriction portions 710 are composed of the cams 288.

In the present exemplary embodiment, as a rotary driving force is transmitted from the driving motor M, which is a drive source, to the pressure applying member 61, a load that causes the pressure applying member 61 to move in the direction away from the outer peripheral surface 51A of the moving member 51 acts on the pressure applying member 61.

More specifically, in the present exemplary embodiment, the transmission gear 289 rotates in a direction represented by an arrow 8A in FIG. 12 and from the transmission gear 289 rotating, a load in a downward direction acts on the receiving gear 290 as represented by an arrow 8B, the receiving gear 290 being disposed to be coaxial with the pressure applying member 61.

In this case, a load that causes the pressure applying member 61 to move in the direction away from the outer peripheral surface 51A of the moving member 51 acts on the pressure applying member 61.

In the present exemplary embodiment, in a case where a rotary driving force is transmitted from the transmission gear 289 to the pressure applying member 61, a load that causes the pressure applying member 61 to move in the direction away from the outer peripheral surface 51A of the moving member 51 acts on the pressure applying member 61.

In the present exemplary embodiment, such a load causes the pressure applying member 61 to move in the direction away from the outer peripheral surface 51A of the moving member 51. However, movement of the pressure applying member 61 caused to move is restricted by the cams 288 which are the restriction portions 710.

In the case of a configuration in which the pressure applying member 61 moves in the direction away from the outer peripheral surface 51A of the moving member 51, a contact pressure at the contact portion N (refer to FIG. 3) is likely to fluctuate and toner image fixation performance with respect to the paper sheet P is likely to fluctuate.

On the other hand, in the case of a configuration in which movement of the pressure applying member 61 is restricted, the contact pressure is less likely to fluctuate, and the fixation performance is less likely to fluctuate.

Furthermore, in the present exemplary embodiment, as described above, the restriction portion 690 that restricts the pressure applying member 61 from further moving toward the pressing member 501 side is provided.

In the present exemplary embodiment, since the restriction portion 690 is provided, a position change of the pressure applying member 61 is made further less likely to occur.

In the present exemplary embodiment, both of movement of the pressure applying member 61 in the direction toward the moving member 51 and the movement of the pressure applying member 61 in the direction away from the moving member 51 are restricted.

### Another Configuration Example of Movement Mechanism

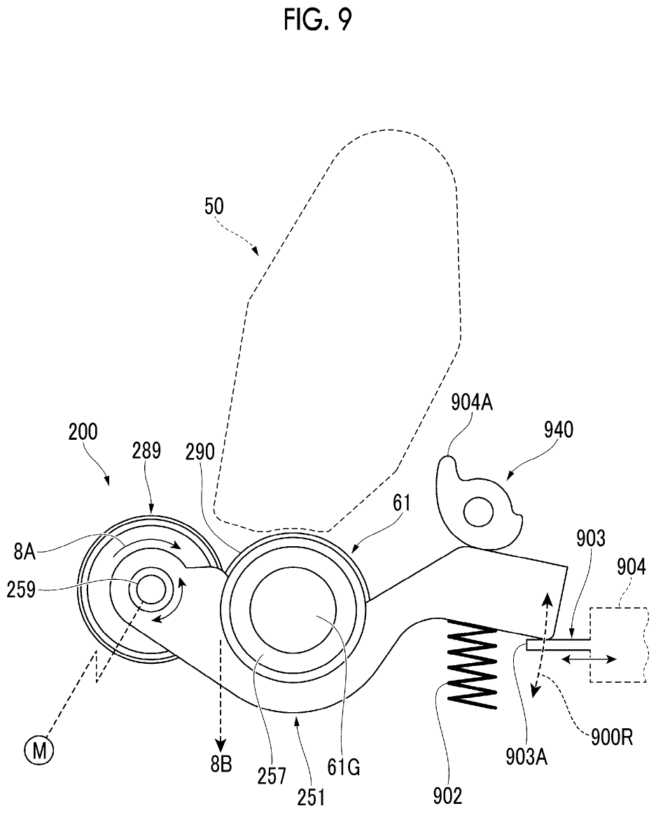

FIG. 9 is a view showing another configuration example of the movement mechanism 200.

In the above-described configuration example, the pressure applying member 61 is urged toward the moving member 51 and the pressure applying member 61 is restricted from moving in the direction away from the moving member 51 by the same cams 288.

The configuration of the movement mechanism 200 is not limited to such a configuration and for example, as shown in FIG. 9, a configuration in which an urging member 902 which is a member provided to urge the pressure applying member 61 toward the moving member 51 and a restriction member 903 which is a member provided to restrict the pressure applying member 61 from moving in the direction away from the moving member 51 are separately provided from each other may also be adopted.

In the configuration example shown in FIG. 9, a movement mechanism 940 for movement of the pressure applying member 61 in the direction away from the moving member 51 is further provided. The movement mechanism 940 is composed of a cam 904A.

In the configuration example shown in FIG. 9, a spring member is provided as the urging member 902 provided to urge the pressure applying member 61.

In addition, in this configuration example, a protruding member 903A that protrudes over a movement route 900R of the support members 251 moving in conjunction with the pressure applying member 61 is provided as the restriction member 903 provided to restrict the pressure applying member 61 from moving in the direction away from the moving member 51.

A frontward and backward movement mechanism 904 causes the protruding member 903A to protrude over the movement route 900R of the support members 251 and to withdraw from the movement route 900R.

The frontward and backward movement mechanism 904 is composed of, for example, a mechanism including a cam, a solenoid, a motor, and the like.

In this configuration example, the cam 904A provided as a portion of the movement mechanism 940 is rotated in one direction so that the pressure applying member 61 moves in the direction away from the moving member 51 (refer to FIG. 3).

In addition, in this configuration example, the cam 904A is rotated in the direction opposite to the one direction so that the pressure applying member 61 moves toward the outer peripheral surface 51A of the moving member 51.

In a case where the cam 904A is rotated in the direction opposite to the one direction, the pressure applying member 61 supported by the support members 251 urged by the urging member 902 is moved toward the moving member 51.

In this configuration example, in a case where the pressure applying member 61 is to be moved toward the moving member 51, the cam 904A is rotated in the above-described opposite direction. Accordingly, the pressure applying member 61 is moved toward the outer peripheral surface 51A of the moving member 51.

In addition, in a case where the pressure applying member 61 is to be moved toward the moving member 51, the cam 904A is rotated in the above-described opposite direction and then the frontward and backward movement mechanism 904 is operated such that the protruding member 903A is positioned on the movement route 900R of the support members 251.

Accordingly, the movement of the pressure applying member 61 in the direction away from the moving member 51 is restricted.

In addition, in this configuration example, in a case where the pressure applying member 61 is to be moved in the direction away from the moving member 51, the frontward and backward movement mechanism 904 is operated such that the protruding member 903A is withdrawn from the movement route 900R of the support members 251 in a state as shown in FIG. 9.

Next, the cam 904A is rotated in the above-described one direction. Accordingly, the pressure applying member 61 moves in the direction away from the moving member 51.

### Operation of Fixing Device

The operation of the fixing device 14 will be described.

In a case where a fixation process is performed by the fixing device 14, power is supplied to the heat source 503A (refer to FIG. 3) and the heat source 504A and the pressure applying member 61 is rotated.

In a case where the pressure applying member 61 is rotated, the moving member 51 starts to circularly move. In the present exemplary embodiment, the temperature of the moving member 51 is increased in a case where the power is supplied to the heat source 503A and the heat source 504A.

Thereafter, the paper sheet P is fed to the contact portion N of the fixing device 14.

In the present exemplary embodiment, as described above, the paper sheet P on which a toner image is formed is heated and pressed at the contact portion N, and thus the toner image is fixed onto the paper sheet P.

After the paper sheet P passes through the contact portion N, the paper sheet P is separated from the moving member 51 and is moved in a direction represented by an arrow 3M in FIG. 3.

A change portion 51H at which the curvature of the moving member 51 changes is present downstream of the contact portion N.

In the present exemplary embodiment, a direction in which the moving member 51 travels and a direction in which the paper sheet P travels are different from each other at the change portion 51H. Accordingly, the paper sheet P is naturally separated from the moving member 51 and the paper sheet P is moved in the direction indicated by the arrow 3M.

The downstream-side paper sheet guide portion 562 that guides the paper sheet P after the paper sheet P passes through the contact portion N is provided downstream of the contact portion N in the movement direction of the paper sheet P.

In a case where the paper sheet P is about to pass through the change portion 51H in a state of adhering to the moving member 51, a leading end portion of the paper sheet P in the movement direction is caught on the downstream-side paper sheet guide portion 562.

Accordingly, the paper sheet P is guided by the downstream-side paper sheet guide portion 562 to be moved in the direction represented by the arrow 3M.

Generally, a toner image is not formed on the leading end portion of the paper sheet P, and the leading end portion of the paper sheet P does not adhere to the moving member 51. In this case, in a case where the paper sheet P is about to pass through the change portion 51H with a portion of the paper sheet P other than the leading end portion adhering to the moving member 51, the leading end portion of the paper sheet P is caught on the downstream-side paper sheet guide portion 562. Accordingly, the paper sheet P is guided by the downstream-side paper sheet guide portion 562 and the paper sheet P is moved in the direction represented by the arrow 3M.

Here, the paper sheets P having various thicknesses are fed to the contact portion N, and for example, in a case where the thickness of the paper sheet P is large, an amount by which the pressing member 501 moves in a case where the paper sheet P passes through the contact portion N is large.

In the case of a configuration in which the amount of movement of the pressing member 501 is large and the pressing member 501 and the upstream-side paper sheet guide portion 561 do not move in conjunction with each other, the positional relationship between the pressing member 501 and the upstream-side paper sheet guide portion 561 is greatly changed.

In a case where the thickness of the paper sheet P is small, the positional relationship between the pressing member 501 and the upstream-side paper sheet guide portion 561 is less likely to change.

In the case of a configuration in which the pressing member 501 and the upstream-side paper sheet guide portion 561 do not move in conjunction with each other, a positional relationship between the pressing member 501 and the upstream-side paper sheet guide portion 561 related to a case where the paper sheet P having a large thickness passes through the contact portion N and a positional relationship between the pressing member 501 and the upstream-side paper sheet guide portion 561 related to a case where the paper sheet P having a small thickness passes through the contact portion N are different from each other.

In this case, the state of the paper sheet P related to a case where the paper sheet P having a large thickness passes through the contact portion N and the state of the paper sheet P related to a case where the paper sheet P having a small thickness passes through the contact portion N are likely to be different from each other.

In this case, a situation may occur in which the posture of a portion of the paper sheet P having a large thickness that is positioned at the contact portion N and the posture of a portion of the paper sheet P having a small thickness that is positioned at the contact portion N are different from each other. In addition, in such a case, the state of fixation on the paper sheet P having a large thickness and the state of fixation on the paper sheet P having a small thickness may be different from each other.

On the other hand, in the case of a configuration in which the pressing member 501 and the upstream-side paper sheet guide portion 561 move in conjunction with each other, the state of the paper sheet P related to a case where the paper sheet P having a large thickness passes through the contact portion N and the state of the paper sheet P related to a case where the paper sheet P having a small thickness passes through the contact portion N are less likely to be different from each other.

In this case, a situation in which the state of fixation on the paper sheet P having a large thickness and the state of fixation on the paper sheet P having a small thickness are different from each other is less likely to occur.

The same applies to the downstream-side paper sheet guide portion 562.

Here, a configuration in which the downstream-side paper sheet guide portion 562 does not move in conjunction with the pressing member 501 will be assumed.

In this case, as with the above-described case, the state of the paper sheet P related to a case where the paper sheet P having a large thickness passes through the contact portion N and the state of the paper sheet P related to a case where the paper sheet P having a small thickness passes through the contact portion N are likely to be different from each other.

On the other hand, in the case of a configuration in which the downstream-side paper sheet guide portion 562 moves in conjunction with the pressing member 501 as in the present exemplary embodiment, the state of the paper sheet P related to a case where the paper sheet P having a large thickness passes through the contact portion N and the state of the paper sheet P related to a case where the paper sheet P having a small thickness passes through the contact portion N are less likely to be different from each other.

### SUPPLEMENTARY NOTE

((1)
A fixing device comprising:
a moving member that circularly moves;
a pressure applying member that is disposed to be in contact with an outer peripheral surface of the moving member, that is used to press a recording medium on which an image is formed, that rotates as the pressure applying member receives a driving force from a drive source, and that presses the recording medium passing through a contact portion between the outer peripheral surface and the pressure applying member;
a pressing member that is disposed inside the moving member, that is urged toward the pressure applying member, that is pressed against the pressure applying member with the moving member interposed therebetween, and that is provided to be movable in a direction away from the pressure applying member; and
a restriction portion that restricts movement of the pressure applying member that is caused to move in a direction away from the outer peripheral surface of the moving member as the driving force is transmitted from the drive source to the pressure applying member.
(((2)))
The fixing device according to (((1))), further comprising:
a guide portion that is provided to move in conjunction with the pressing member and that guides the recording medium moving toward the contact portion.
(((3)))
The fixing device according to (((2))),
wherein a position of the guide portion with respect to a movement route of the recording medium changes in response to movement of the pressing member in the direction away from the pressure applying member.
(((4)))
The fixing device according to (((3))),
wherein the moving member and the pressing member are provided on one side with respect to the movement route of the recording medium,
the guide portion is provided on the other side with respect to the movement route of the recording medium, and
the guide portion moves toward a side, on which the movement route is provided, in response to the movement of the pressing member in the direction away from the pressure
((5)))
The fixing device according to any one of (((1))) to), further comprising:
a pushing member that pushes an inner peripheral surface of the moving member in a direction toward an outside of the moving member having an annular shape and/or a pushing member that pushes the outer peripheral surface of the moving member in a direction toward an inside of the moving member having the annular shape.
(((6)))
The fixing device according to any one of (((1) to
wherein the pressing member moves toward a pressure applying member side, which is a side on which the pressure applying member is positioned, as the pressure applying member moves in the direction away from the outer peripheral surface of the moving member, and
the fixing device further comprises a restriction portion that restricts movement of the pressing member moving toward the pressure applying member side.
(((7)))
The fixing device according to any one of (((1))) to (((5))), further comprising:
a movement mechanism that moves the pressing member in the direction away from the pressure applying member.
(((8)))
The fixing device according to (((7))),
wherein, in a case where the pressure applying member is moved in the direction away from the outer peripheral surface of the moving member, the movement mechanism moves the pressing member in the direction away from the pressure applying member.
(9)
The fixing device according to any one of (((1))) to (((8))), further comprising:
a guide portion that guides the pressing member moving in the direction away from the pressure applying member.
(((10)))
The fixing device according to (((9))),
wherein the guide portion guides the pressing member such that the pressing member moves in the direction away from the pressure applying member in a state where a posture of the pressing member before the movement of the pressing member in the direction away from the pressure applying member is maintained.
(((11)))
The fixing device according to (((9))),
wherein the pressing member includes a downstream-side end portion that is an end portion positioned on a downstream side in a movement direction of the recording medium and an upstream-side end portion that is an end portion positioned on an upstream side in the movement direction of the recording medium, and
a downstream-side guide portion that guides the downstream-side end portion and an upstream-side guide portion that guides the upstream-side end portion are provided as the guide portions.
(((12)))
The fixing device according to any one of (((1))) to ((11))), further comprising:
a restriction portion that restricts the pressure applying member from further moving toward a pressing member side, which is a side on which the pressing member is positioned, in a state where the pressure applying member is in contact with the outer peripheral surface of the moving member.
(((13)))
The fixing device according to (((12))),
wherein a movement portion that moves in conjunction with the pressure applying member abuts against the restriction portion so that the pressure applying member is restricted from moving toward the pressing member side.
(((14)))
The fixing device according to any one of (((1))) to (((13))), further comprising:
a guide portion that is provided to move in conjunction with the pressing member and that guides the recording medium passing through the contact portion.
(((15)))
An image forming apparatus comprising:
an image formation unit that forms an image on a recording medium; and
a fixing device that fixes, onto the recording medium, the image that is formed on the recording medium by the image formation unit,
wherein the fixing device includes the fixing device according to any one of (((1))) to (((14))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a moving member that circularly moves;
a pressure applying member that is disposed to be in contact with an outer peripheral surface of the moving member, that is used to press a recording medium on which an image is formed, that rotates as the pressure applying member receives a driving force from a drive source, and that presses the recording medium passing through a contact portion between the outer peripheral surface and the pressure applying member;
a pressing member that is disposed inside the moving member, that is urged toward the pressure applying member, that is pressed against the pressure applying member with the moving member interposed therebetween, and that is provided to be movable in a direction away from the pressure applying member; and
a restriction portion that restricts movement of the pressure applying member that is caused to move in a direction away from the outer peripheral surface of the moving member as the driving force is transmitted from the drive source to the pressure applying member.

2. The fixing device according to claim 1, further comprising:
a guide portion that is provided to move in conjunction with the pressing member and that guides the recording medium moving toward the contact portion.

3. The fixing device according to claim 2,
wherein a position of the guide portion with respect to a movement route of the recording medium changes in response to movement of the pressing member in the direction away from the pressure applying member.

4. The fixing device according to claim 3,
wherein the moving member and the pressing member are provided on one side with respect to the movement route of the recording medium,
the guide portion is provided on the other side with respect to the movement route of the recording medium, and
the guide portion moves toward a side, on which the movement route is provided, in response to the movement of the pressing member in the direction away from the pressure applying member.

5. The fixing device according to claim 1, further comprising:
a pushing member that pushes an inner peripheral surface of the moving member in a direction toward an outside of the moving member having an annular shape and/or a pushing member that pushes the outer peripheral surface of the moving member in a direction toward an inside of the moving member having the annular shape.

6. The fixing device according to claim 1,
wherein the pressing member moves toward a pressure applying member side, which is a side on which the pressure applying member is positioned, as the pressure applying member moves in the direction away from the outer peripheral surface of the moving member, and
the fixing device further comprises a restriction portion that restricts movement of the pressing member moving toward the pressure applying member side.

7. The fixing device according to claim 1, further comprising:
a movement mechanism that moves the pressing member in the direction away from the pressure applying member.

8. The fixing device according to claim 7,
wherein, in a case where the pressure applying member is moved in the direction away from the outer peripheral surface of the moving member, the movement mechanism moves the pressing member in the direction away from the pressure applying member.

9. The fixing device according to claim 1, further comprising:
a guide portion that guides the pressing member moving in the direction away from the pressure applying member.

10. The fixing device according to claim 9,
wherein the guide portion guides the pressing member such that the pressing member moves in the direction away from the pressure applying member in a state where a posture of the pressing member before the movement of the pressing member in the direction away from the pressure applying member is maintained.

11. The fixing device according to claim 9,
wherein the pressing member includes a downstream-side end portion that is an end portion positioned on a downstream side in a movement direction of the recording medium and an upstream-side end portion that is an end portion positioned on an upstream side in the movement direction of the recording medium, and
a downstream-side guide portion that guides the downstream-side end portion and an upstream-side guide portion that guides the upstream-side end portion are provided as the guide portions.

12. The fixing device according to claim 1, further comprising:
a restriction portion that restricts the pressure applying member from further moving toward a pressing member side, which is a side on which the pressing member is positioned, in a state where the pressure applying member is in contact with the outer peripheral surface of the moving member.

13. The fixing device according to claim 12,
wherein a movement portion that moves in conjunction with the pressure applying member abuts against the restriction portion so that the pressure applying member is restricted from moving toward the pressing member side.

14. The fixing device according to claim 1, further comprising:
a guide portion that is provided to move in conjunction with the pressing member and that guides the recording medium passing through the contact portion.

15. An image forming apparatus comprising:
an image formation unit that forms an image on a recording medium; and
a fixing device that fixes, onto the recording medium, the image that is formed on the recording medium by the image formation unit,
wherein the fixing device includes the fixing device according to claim 1.

16. An image forming apparatus comprising:
an image formation unit that forms an image on a recording medium; and
a fixing device that fixes, onto the recording medium, the image that is formed on the recording medium by the image formation unit,
wherein the fixing device includes the fixing device according to claim 2.

17. An image forming apparatus comprising:
an image formation unit that forms an image on a recording medium; and
a fixing device that fixes, onto the recording medium, the image that is formed on the recording medium by the image formation unit,
wherein the fixing device includes the fixing device according to claim 3.

18. An image forming apparatus comprising:
an image formation unit that forms an image on a recording medium; and
a fixing device that fixes, onto the recording medium, the image that is formed on the recording medium by the image formation unit,
wherein the fixing device includes the fixing device according to claim 4.

19. An image forming apparatus comprising:
an image formation unit that forms an image on a recording medium; and
a fixing device that fixes, onto the recording medium, the image that is formed on the recording medium by the image formation unit,
wherein the fixing device includes the fixing device according to claim 5.

20. An image forming apparatus comprising:
an image formation unit that forms an image on a recording medium; and
a fixing device that fixes, onto the recording medium, the image that is formed on the recording medium by the image formation unit,
wherein the fixing device includes the fixing device according to claim 6.
